(19) United States
(12) Patent Application Publication
(10) Pub. No.: US 2004/0068757 A1
(43) Pub. Date: Apr. 8, 2004

(54) Digital signatures for digital television applications

(76) Inventor: Edwin Arturo Heredia, San Jose, CA (US)

Correspondence Address: LEE & HAYES PLLC, 421 W RIVERSIDE AVENUE SUITE 500, SPOKANE, WA, 99201

(21) Appl. No.: 10/658,077

(22) Filed: Sep. 9, 2003

Related U.S. Application Data
(60) Provisional application No. 60/417,404, filed on Oct. 8, 2002.

(51) Int. Cl. H04N 11/00; H04N 7/00; H04N 7/16; H04N 7/167

(52) U.S. Cl. 725/135; 725/136; 348/461; 725/31

(57) ABSTRACT

A supplemental television content application architecture, associated methods creating and executing a signed supplemental television content application, and media having instructions for executing associated the methods are described. The architecture includes a signature for a cluster of at least a portion of the application files detached from the application files, and a start file having either an expression or a link to an expression having a link to each signature. The architecture also includes a web page comprising at least a portion of the application files that is coded with an attached signature or a link to the signature.

### RELATED APPLICATIONS

This patent application claims priority to U.S. Provisional Patent Application No. 60/417,404 filed Oct. 8, 2002, which is hereby incorporated by reference.

### TECHNICAL FIELD

This invention relates generally but not exclusively to security of supplemental or interactive television content, and more particularly but not exclusively relates to signing supplemental or interactive television content.

### BACKGROUND

Traditional television content, such as shows and pay-per-view movies (hereafter program(s)), are generally delivered to a viewer as a continuous video stream. Traditional television content is most commonly distributed using a wireless broadcast system or a cable system. In the first instance, the content is received at individual homes through an antenna or a satellite dish. In the latter instance, the content is usually received through coaxial cable that terminates at set-top boxes.

To enhance the traditional way of viewing a program, there has been some effort toward the production of supplemental television content. As presently contemplated, the supplemental television content is created to provide enhanced content to the traditional television content. The supplemental content may be played along with the traditional television content, either displayed on the same region of a display device as the traditional television content, or displayed on a separate region of a display device from the traditional television content.

The supplemental content may furthermore be interactive content, enabling viewers to interact with the television program or the supplemental content in a more involved manner than simply watching the television program. The supplemental television content may, for example, ask the viewer questions about the television content, such as during a presidential debate, asking the viewer his or her presidential preference after each question in the debate; or asking a viewer questions about an advertised product. The supplemental television content may, for example, additionally play games with the viewer relating to the television content, describe behind-the-scenes aspects of making the program, or provide links to stores that sell merchandise that is sponsored by the program. In addition, the supplemental television content may not be tied to a particular program, but instead convey general information, such as tickers for news headlines, weather information, sports scores, and so forth.

One common approach today is to provide supplemental content to a viewer in the form of supplemental content applications, an application being a collection of files carrying code and associated objects (text, images, voice, audio, video, etc). Supplemental content may be delivered using the same communication channels as the broadcast media, or may be delivered through separate interconnecting channels like an Internet connection. Because the files that define an application carry instructions that will be executed by a receiver, it could happen that some unauthorized entity inserts damaging code as part of one of the application files before reception by the viewer. Upon execution, this piece of code may perform some unwanted operations in the receiver device. Examples of unwanted operations could be the blocking of certain TV channels, the display of annoying messages, or more serious such as reading private information, or using the client receiver to launch distributed denial of service attacks.

Because a file could be modified by an unauthorized entity, it is very convenient to digitally sign a supplemental content file as a means to provide integrity checking and source authentication at the receiver end. A digitally signed file gives a receiver an instrument and basis to detect if a file had been modified from the time it was digitally signed. An unauthorized entity that inserts or replaces file content from an original file will be detected by receivers that verify the status of the signature. A digitally signed file also gives the receiver an instrument and basis to verify that the signed file has an unbreakable binding to a particular signer whose identity must be registered by commonly available certification authorities. It would be convenient to have a method and device to associate a digital signature with an application or collection of files.

### SUMMARY

Briefly and not exclusively, a supplemental television content application architecture, associated methods creating and executing a signed supplemental television content application, and media having instructions for executing the methods are described.

In one exemplary embodiment, an architecture includes a signature for a cluster of at least a portion of the application files detached from the application files; and a start file having either an expression or a link to an expression having a link to each signature. The architecture also includes a web page comprising at least a portion of the application files that is coded with an attached signature or a link to the signature.

In one exemplary embodiment, a method includes identifying at least a first portion of the files in at least one cluster, determining a cluster signature for each cluster, and developing an expression that includes the location of the signature.

In one exemplary embodiment, a method includes identifying a first portion of the files that together compose a web page, determining a signature for the web page; and either storing a link to the signature in the web page, or the signature in the web page.

In one embodiment, a method includes determining if any of the files are arranged in a cluster. For each cluster, the method includes determining the location of the signature of the cluster determining the files that compose the cluster and verifying the integrity of the files in the cluster by operations including verifying the signature.

In one embodiment, a method includes determining if any files compose web pages. If any of the files compose web pages, then for each the web page, the method includes decoding the web page to determine if the web page has either a link to a digital signature or a digital signature, reading the signature, and verifying the signature.

### BRIEF DESCRIPTION OF THE DRAWINGS

The detailed description is described with reference to the accompanying figures.

FIG. 1 is an exemplary block diagram of a security information resource file.

FIG. 2 is a block diagram representation of an exemplary centralized architecture where a reference to digital signature data is incorporated in a start file.

FIG. 3 is a block diagram representation of an exemplary centralized architecture where a link to digital signature data is incorporated in a start file.

FIG. 4 portrays an exemplary XML metadata schema for a centralized architecture security information resource file.

FIG. 5 portrays an exemplary XML metadata schema for an element for specifying a location of a detached signature file for the centralized architecture security information resource file portrayed in FIG. 4.

FIG. 6 portrays an exemplary XML metadata schema for an element for specifying delegate information for the centralized architecture security information resource file portrayed in FIG. 4.

FIG. 7 portrays an exemplary XML metadata schema for an element for specifying delegate constraints for the centralized architecture security information resource file portrayed in FIG. 4.

FIG. 8 portrays an exemplary XML metadata schema for an element for specifying cluster information for the centralized architecture security information resource file portrayed in FIG. 4.

FIG. 9 portrays an exemplary XML metadata schema for an element for specifying cluster information for the centralized architecture security information resource file portrayed in FIG. 4.

FIG. 10 is a block diagram representation of an exemplary decentralized architecture where the signature data and the security information resource file are attached files.

FIG. 11 is a block diagram representation of an exemplary decentralized architecture where a link to the signature data and the security information resource file are attached files, and the digital signature is a detached file.

FIG. 12 portrays an exemplary XML metadata schema for a decentralized architecture security information resource file.

FIG. 13 portrays an exemplary XML metadata schema for time stamp versioning.

FIGS. 14A-14B portrays an exemplary method associating a supplemental content application with its digital signatures.

FIG. 15 portrays an exemplary method processing digital signatures upon receiving a supplemental television content application.

### DETAILED DESCRIPTION

In this description, reference is made to the accompanying drawings which form a part hereof, and in which is shown, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Before describing embodiments, it is useful to describe some concepts used herein. Supplemental content is composed of individual files. A collection of these individual files is termed an application. Typically in television having supplemental content, an application starts with a start file. A start file is a file or a data structure that describes parameters to execute an associated application. A subset of application files is termed a cluster. Clusters are useful for grouping files that may have a logical organization and may be commonly signed. For example all files representing objects for a web page may constitute a logical cluster. Similarly, all web pages that form a section in an electronic newspaper may constitute another logical cluster. A main cluster is an application file subset that includes a security information resource file as described herein.

A file is said to be static during a time interval if during the time interval, the file does not change its content. A file is said to be dynamic during a time interval if during the time interval, the file changes its content at least one time. For example, a daily electronic newspaper may maintain an application (the daily newspaper) for an interval lifetime of one day. During the interval lifetime, some files may change their content and are therefore said to be dynamic during the interval. Illustratively, a page containing the latest news in the electronic newspaper may update headlines continuously during the interval of the file having the headline. Others may not change and are therefore termed static during the interval lifetime.

An application is said to be static during a time interval if during the time interval, each file in the application is static and the collection of files that compose the application remains constant. An application is said to be dynamic during the time interval, if during the time interval it is not static. During an application lifetime, new files of an application could be created or incorporated into the application. For example, in an e-commerce transaction, a server may not know a priori the type of items a user may be interested in looking at. Upon request, the server may create a web page dynamically according to the user's preferences and interests.

A cluster is said to be static during a time interval if during the time interval, each file in the cluster is static, and the collection of files in the cluster remains constant. A cluster is said to be dynamic during the time interval, if during the time interval it is not static.

A Web-Page or Web-Page Cluster is a grouping of files (e.g. text files, image files, script files) that may be displayed together as a single page. A Web-Page File is a file that includes hypertext markup language (HTML) or extensible hypertext markup language (XHTML) (or other markup representation) and which describes the presentation and layout for a Web-Page Cluster.

A detached signature is a signature that exists as a separate file and which is used to sign one or more application files, such as each of the files composing a cluster. An attached signature is a signature that exists as internal data in a file, and which is used to sign the file that hosts the signature. If the file that hosts the signature is a Web Page File that is a constituent of a Web Page Cluster, the same signature can be used to sign files in the Web Page Cluster.

Described herein is a structure and method for signing a supplemental television content application. The structure includes two architectures for signing applications, a centralized architecture and a decentralized architecture, both of which are described presently. Both the centralized architecture and the decentralized architecture may be used in different portions of the same application.

The centralized architecture uses a start file to indicate the location of digital signatures. In the centralized architecture, a file termed the security information resource file includes a specification of the location of the signature file, for each file cluster referenced in the security information resource file. In one implementation, the start file includes the security information resource file. In another implementation, the start file includes a reference (or link) to the location of the security information resource file.

The decentralized architecture does not use a start file to indicate the location of the digital signatures, but instead includes a digital signature as an attached file in an application file, or alternatively a link to the digital signature from an attached file in the application file. The decentralized architecture may use a security information resource file to provide other application signing information. Illustrative embodiments of the centralized and the decentralized architecture are described presently.

Security Information Resource File

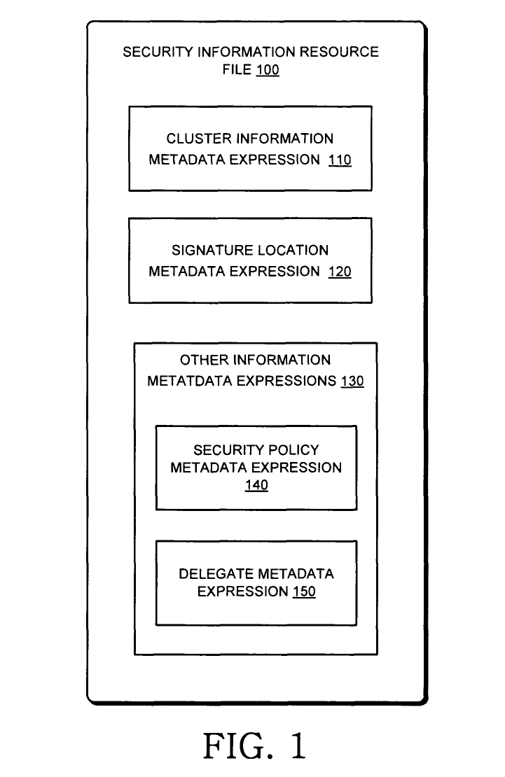

FIG. 1 portrays an exemplary security information resource file 100. A security information resource file 100 is a collection of expressions that provide overall information about signing an application. The security information resource file 100 in the centralized architecture may exist as additional data in a start file, or as a separate file referenced from the start file. The security information resource file 100 in the decentralized architecture may exist as an attached file in an application file or Web Page.

In one implementation, the security information resource file 100 is implemented using a markup language such as Extensible Markup Language (XML). XML is a flexible way to create common information formats and share both the format and the data on the World Wide Web, intranets, and elsewhere. In one implementation, the security information resource file 100 is signed to prevent unauthorized modifications to the information.

In the centralized architecture, the security information resource file 100 includes a cluster information metadata expression 110 for each defined cluster of the application, to identify each cluster. Clusters are used to group files so that one digital signature is used for signing the cluster, rather than separately signing each file of the cluster. In the centralized architecture, the security information resource file 100 includes a signature location metadata expression 120 for each identified cluster. The signature location metadata expression 120 for each identified cluster describes the location, such as a Uniform Resource Locator (URL) or link, of the detached signature for that cluster.

The security information resource file 100 may include other information metadata expressions 130 that describe other information about the digitally signed applications. The other information metadata expressions 130 in one implementation may include security policy metadata expressions 140 having links to documents describing security policies. The other information metadata expressions 130 in one implementation may describe delegate metadata expressions 150 identifying delegates that may sign a cluster for at least one identified cluster(s)in addition to the main signer, or delegates that may sign the application in addition to the main signer. Certain components of an application might be generated by parties other than the main entity. In one implementation receivers of supplemental applications recognize these other parties as trusted originating entities. For example, a network that distributes software to hundreds of broadcast affiliates may allow affiliates to insert software components for local commercials. The term delegate refers to a certain party other than the principal source entity that signs portions of an application using detached cluster signatures, attached file signatures, or attached message signatures.

Examples of both a centralized and a decentralized architecture security information resource file 100, and a centralized and a decentralized architecture system, are given below.

Centralized Architectures

In one implementation, the security information resource file 100 is described using XML schema. In a centralized architecture, the security information resource file 100 includes a reference to the digital signature for each described cluster, and a description of the application clusters.

In one implementation, the security information resource file 100 may also include other information. This other information may include links to documents describing security policies; and the identities, properties, and constraints of delegates (if any) that may sign a cluster(s) or an application in addition to the main signer.

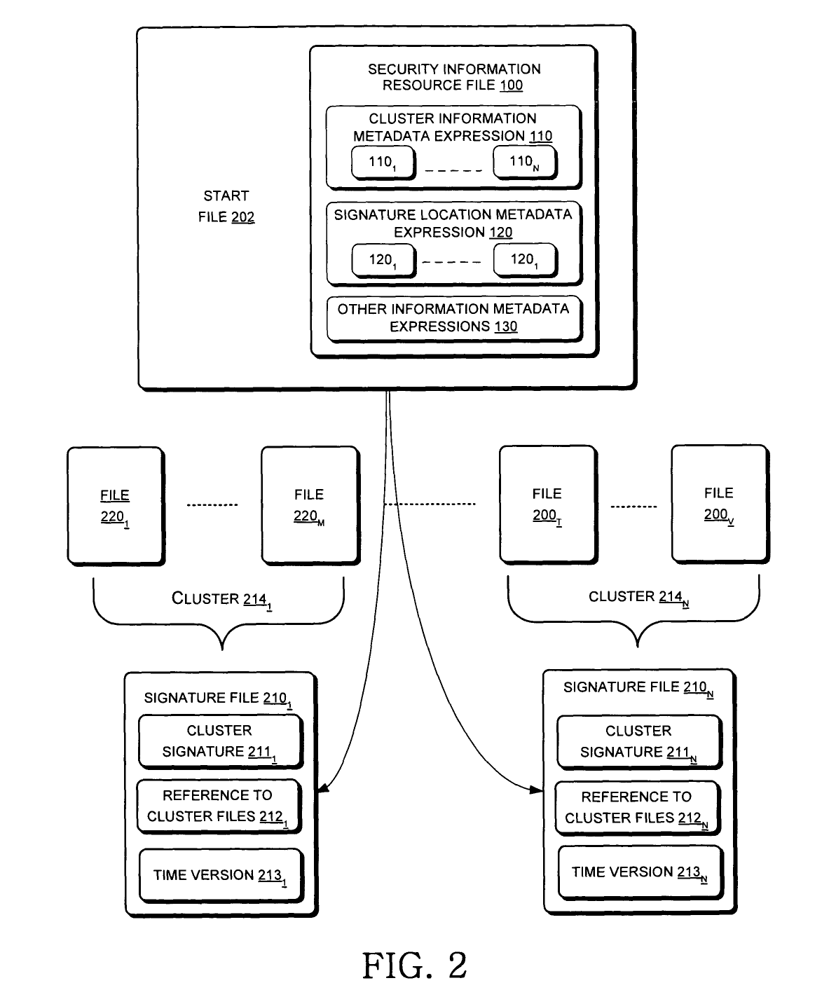

FIG. 2 portrays an implementation of a centralized architecture in which a reference to the digital signature data is incorporated into the start file. Referring now to FIG. 2, a start file 202 includes a centralized architecture security information resource file 100. The centralized architecture security information resource file 100 is a collection of expressions that provides overall information about signing the application.

The centralized architecture security information resource file 100 includes a cluster information metadata expression 110ᵢ for each cluster “i”, i=1 to n to name each cluster “i.” The centralized architecture security information resource file 100 includes a signature location metadata expression 120ᵢ for each identified cluster 214ᵢ, i=1 to n. The signature location metadata expression 120ᵢ describes the location, such as a URL or link, of the detached signature file 210ᵢ for the cluster 214ᵢ. Each cluster 214ᵢ is associated with respective files 220. Illustratively, cluster 214₁ is associated with the files 220₁-220ₘ, and cluster 210ₙ is associated with the files 220ₜ-220ᵥ. A detached signature file 210ᵢ includes the digital signature 211ᵢ of the cluster 214ᵢ. The signature 211ᵢ may include the hash code of each of the files composing the cluster, and a digital signature for signing at least the hash codes of each of the files. The process of signing a cluster entails calculating the cluster digital signature 211ᵢ. For a static cluster, the cluster signature may only be calculated once. For a dynamic cluster, the cluster signature may be calculated each time a file of the cluster changes. Thus, a selection of a cluster should reflect the quantity of files in the cluster, as well the dynamic nature of the files in the cluster. The digital signature file 210ᵢ may include a reference to cluster files 212ᵢ referencing a location or an identification of the files 220 composing the cluster 214ᵢ. In one implementation, the reference to the files is stored outside the signature file 210ᵢ, such as in the security information resource file 100. The digital signature file 210ᵢ may include a time verification record 213ᵢ for describing the version of the signature as a function of the files 220ᵢ composing the cluster 214ᵢ. This may be used for determining whether a signature 211ᵢ reflects the current cluster files for a dynamic cluster. In one implementation the time verification record 213ᵢ is stored outside the signature file 210ᵢ, such as in the security information resource file 100.

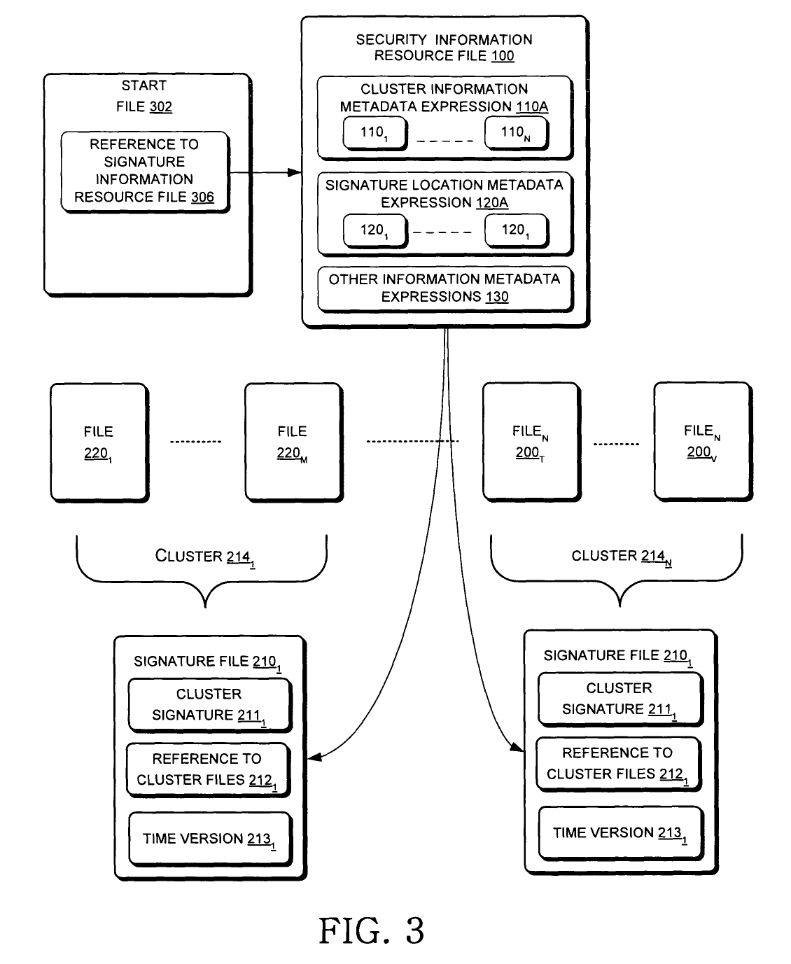

FIG. 3 portrays an implementation of a centralized architecture in which a reference for accessing a reference to the digital signature data is incorporated into the start file. Referring to FIG. 3, a start file 302 includes a reference to centralized architecture security information resource file 100. As described with reference to FIG. 2, the centralized architecture security information resource file 100 includes a cluster information metadata expression 110 for clusters 1 to “n,” and a signature location metadata expression 120 for clusters 1 to “n” that specifies the location of the cluster signature files 210₁-210ₙ, each signature file 210ᵢ containing a detached digital signature 211ᵢ associated respectfully with a cluster 214ᵢ. In one implementation, the centralized architecture security information resource file 100 also includes other information metadata expressions 130, such as links to documents describing security policies; and the identities, properties, and constraints of delegates (if any) that may sign an application.

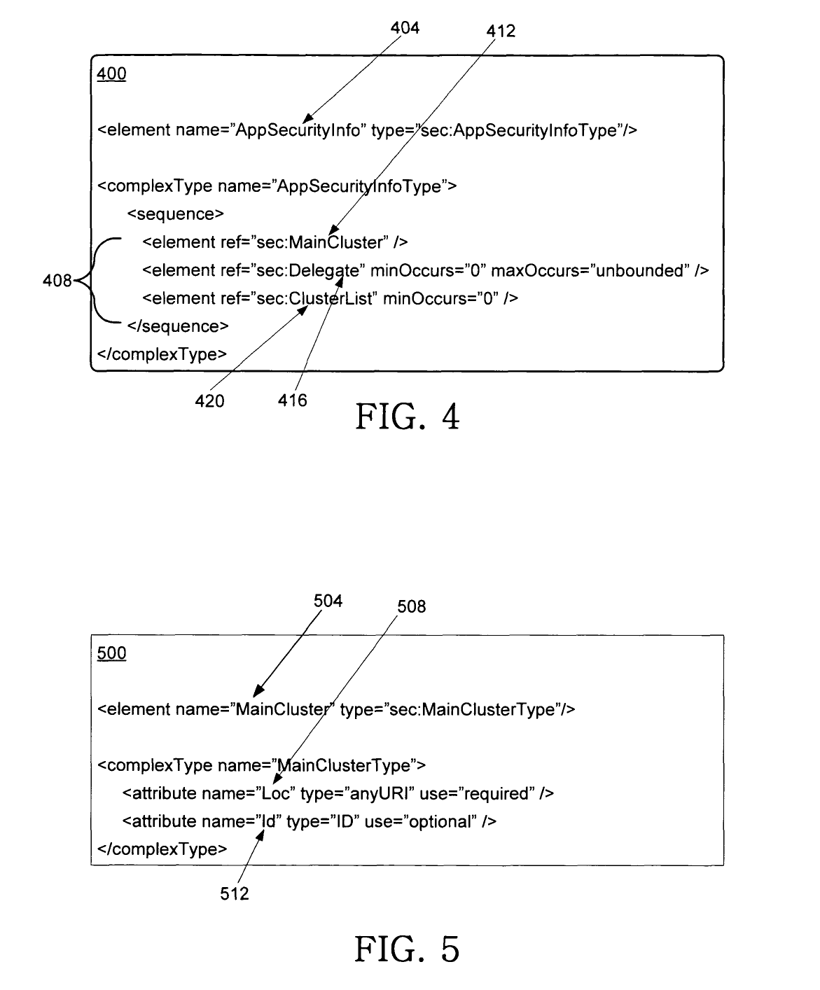

FIG. 4 presents an illustrative XML metadata schema 400 for defining the structure and components 408 of an exemplary document root of the centralized architecture security information resource file 100. The element AppSecurityInfo 404 is the document root. The components 408 include the element MainCluster 412, the element Delegate 416, and the element ClusterList 420.

FIG. 5 presents an illustrative metadata schema 500 to specify a structure of the element MainCluster 412 (FIG. 4). Element MainCluster 504 specifies a location of the detached signature file 210ᵢ (FIG. 2 or 3). The attribute Loc 508 indicates the location from which the signature file of the main cluster may be retrieved, formatted as a Uniform Resource Identifier (URI). The attribute Id 512 is optional and used for referencing element MainCluster from other parts of the parent document or other documents.

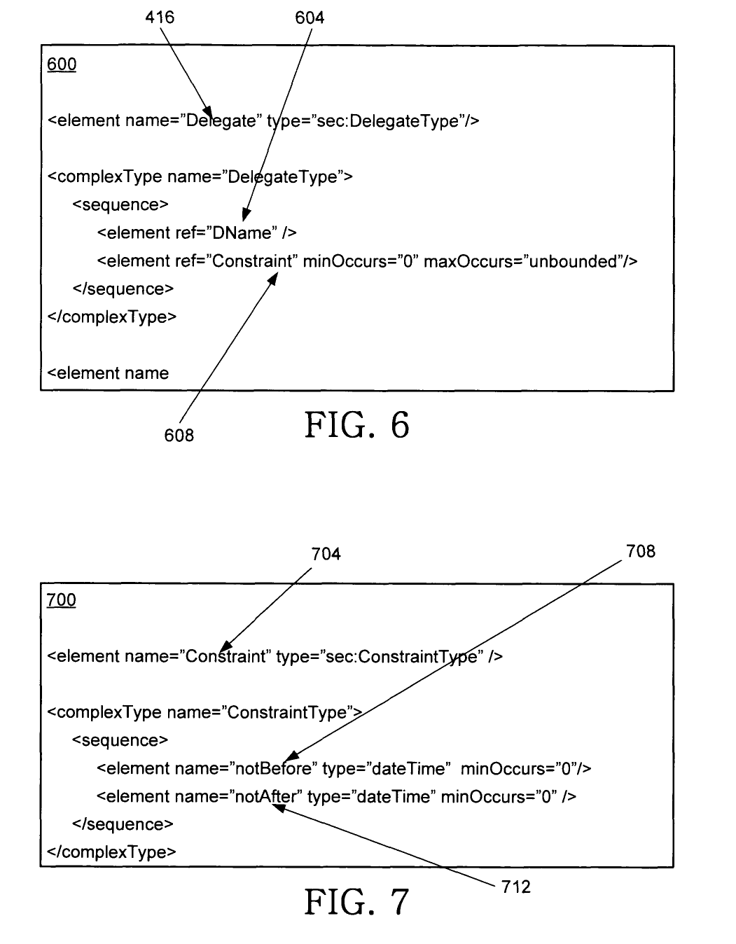

FIG. 6 presents an illustrative metadata schema 700 to specify a structure of the element Delegate 416 (FIG. 4). The element Delegate 416 specifies name identification for delegate entries capable of signing portions of an application with permission of the application's Principal Source Entity. This element may appear outside or inside a cluster list in the centralized architecture signature information metadata 100.

Appearance outside the cluster list may indicate that the named delegate may sign different portions of the application without constraints. The Delegate may sign files using cluster signature files, attached file signatures, or attached message signatures. In particular, the delegate may sign trigger resources (one kind of attached file signature). Appearance inside the cluster list may indicate that the named Delegate may sign only the corresponding cluster signature file.

The element DName 604 provides the delegate's distinguished name, for matching with similar information in the delegate's certificate. Zero or more elements termed Constraint 608 may describe constraints on the ability to sign application portions. A schema that defines the element DName is: <element name=“DName” type=“string”/>. The rules for accurately representing the distinguished name as a text string are similar to the rules for encoding the element X509SubjectName described in the XML Digital Signature Standard, RFC3275, “XML-Signature Syntax and Processing,” Internet Engineering Task Force (IETF), March 2002.

FIG. 7 presents an illustrative metadata schema 700 to specify the structure of the element Constraint 704. The element Constraint 704 specifies a constraint that may be imposed on the delegates. The notBefore element 708 and the notAfter element 712 are one implementation to provide time boundaries to a delegate's ability to sign portions of an application.

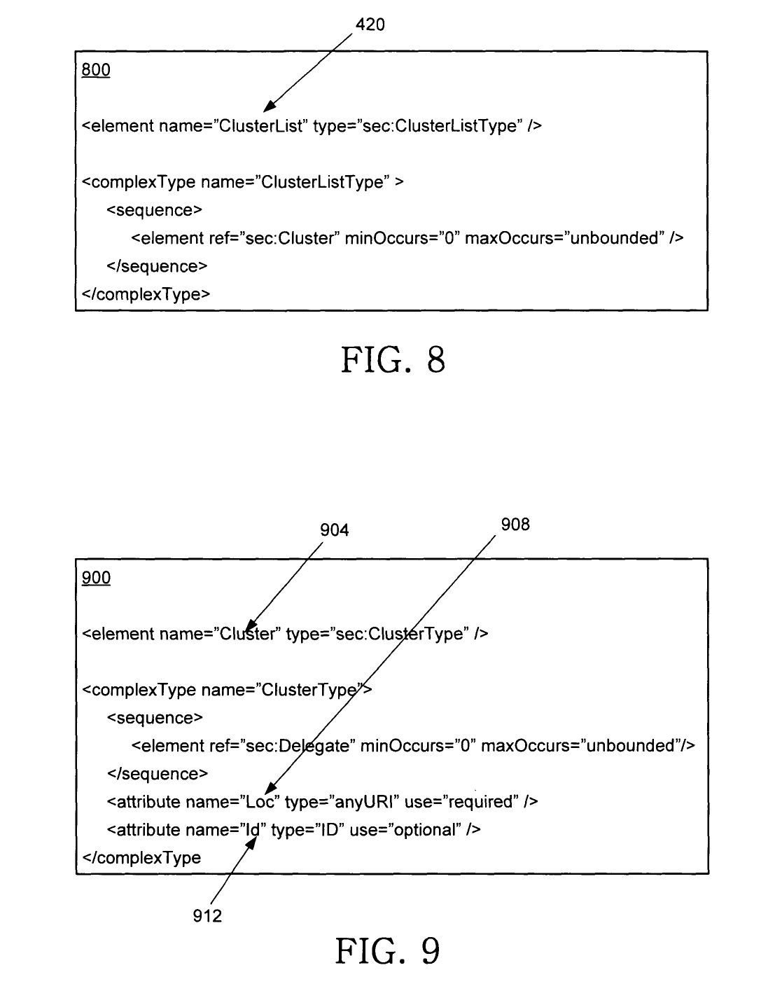

FIG. 8 presents an illustrative metadata schema 800 specifying the element ClusterList 420 (FIG. 4). The element ClusterList 420 defines a wrapper for all the clusters that compose an application.

FIG. 9 presents an illustrative metadata schema 900 that specifies the element Cluster 904. The attribute Loc 908 indicates the URI from which to receive the cluster signature file. The attribute ID 912 is optional and used for referencing the element Cluster 904 from other parts of the parent document or other documents.

Decentralized Architectures

The security information resource file 100 is described using XML schema. A decentralized architecture describes a security information resource file 100 as an attached file. The decentralized architecture signature data is alternatively an attached signature data, or a separate detached signature file where an attached link in a Web Page file points to the detached signature file.

One of the features of the structure described herein is an ability to sign dynamic applications. In one implementation described above with reference to the centralized architecture, dynamic applications are signed using clusters having corresponding signature files that change with file changes. In another implementation, attached file signatures, or links to attached file signatures are used, that change as the associated file changes. A decentralized architecture enables the association of signatures directly to individual web-pages. A decentralized architecture can be used for the static or dynamic web pages of markup language based applications, and for web pages created dynamically by procedural applications at the client side. The decentralized architecture does not rely upon clusters. Thus in the decentralized architecture, a security information resource file includes signature data but need not include a description of the application clusters. In one implementation, the security information resource file 100 includes other information about digitally signed applications, such as links to documents describing security policies and the identities of delegates that may sign the application in addition to the main signer.

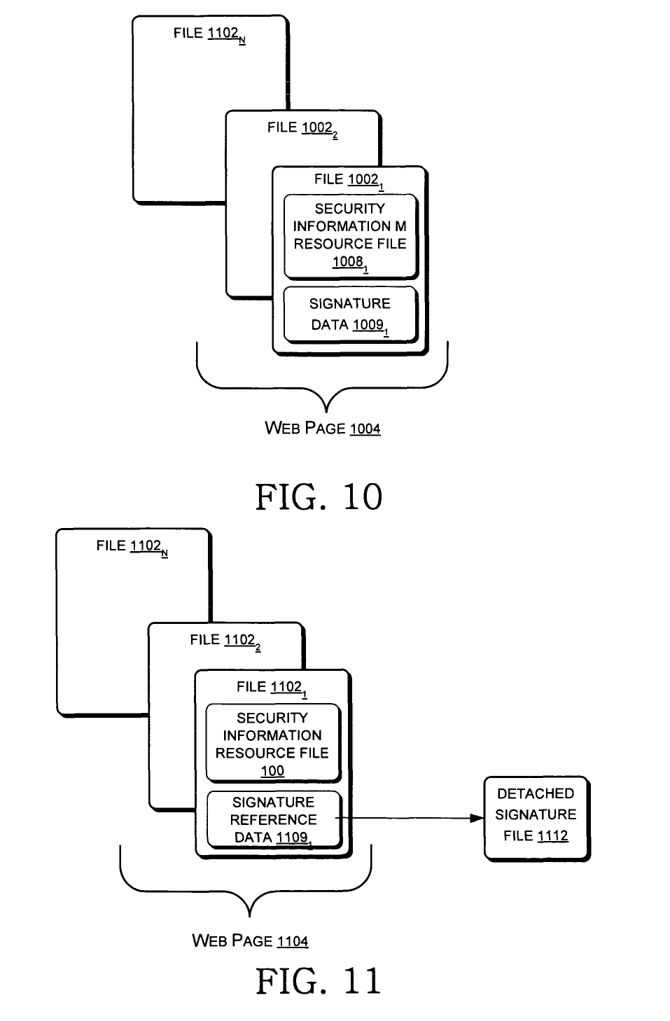

FIG. 10 portrays an implementation of a decentralized architecture in which a security information resource file 1008₁ and signature data 1009₁ are established as attached files. Referring to FIG. 10, the files 1002₁-1002ₙ compose a Web Page 1004. The file 1002₁ may include a security information resource file 1008. The security information resource file 1008 includes optional information about signing the Web Page 1004 such as links to documents describing security policies, and the identities, properties, and constraints of delegates (if any) that may sign an application. The File 1002₁ includes an attached signature data 1009₁ for the Web Page 1004. In one implementation, the signature data 1009₁ may be included as a component of the security information resource file 1008₁.

FIG. 11 portrays an implementation of a decentralized approach in which a security information resource file 100 is established as an attached file. Referring now to FIG. 11, the files 1102₁-1102ₙ compose a Web Page 1104. The file 1102₁ may include a security information resource file 100. The security information resource file 100 includes optional information about signing the Web Page 1104 such as links to documents describing security policies, and the identities, properties, and constraints of delegates (if any) that may sign an application. The file 1102₁ includes signature reference data 1109₁ referencing (or linking to) a detached signature file 1112.

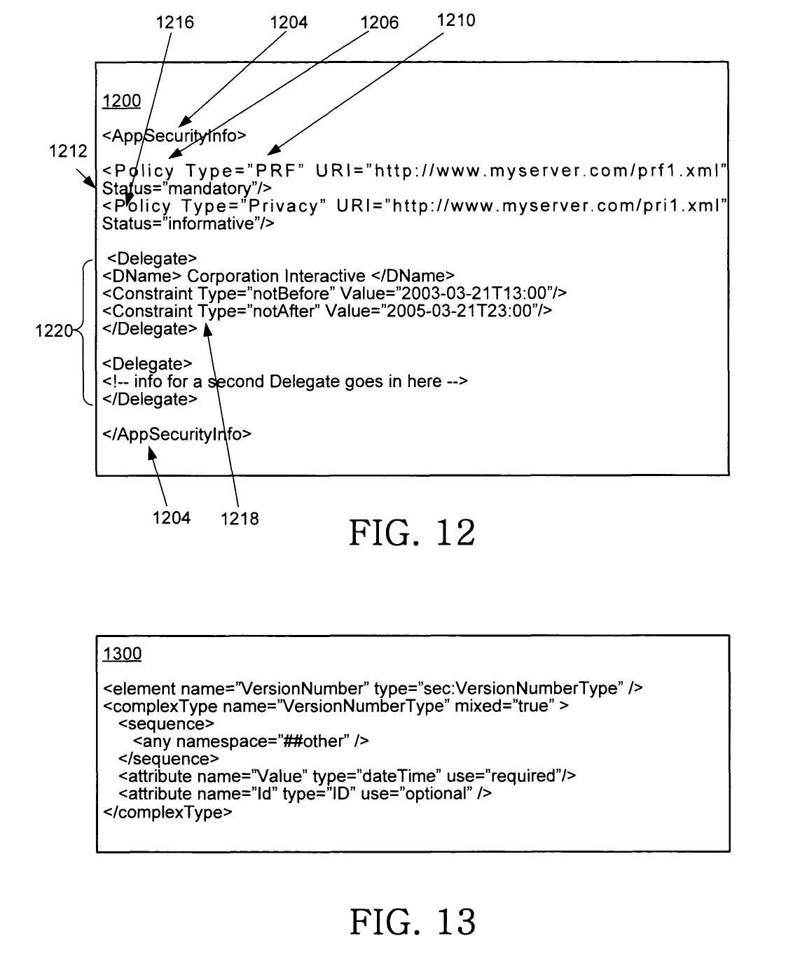

FIG. 12 presents an illustrative XML metadata representation of a decentralized architecture security information resource file. The XML metadata representation 1200 starts and ends with <AppSecurityInfo> elements 1204 as it did in the illustrative centralized approach with reference to the centralized architecture schema 400 portrayed in FIG. 4. Notice that unlike the centralized architecture schema 400, the decentralized representation 1200 carries no information about clusters, because a decentralized architecture does not require cluster information in advance. In one implementation, information for policies and delegates can exist inside the <AppSecurityInfo> elements 1204.

Two policy declarations have been illustratively provided. The first policy declaration 1206 specifies the location of a PRF (Permission Request File) 1210. A PRF typically indicates allowed and disallowed operations for an application. Notice that the attribute called “Status” 1212 indicates whether the schema 1200 must be interpreted and decoded for security reasons. The second policy declaration 1216 defines the location of a file that may contain a privacy statement from the application developer. Other policy files may be included similarly.

The schema 1200 includes a list of Delegates 1220. Delegates are entities (persons or organizations) that may sign portions of an application in addition to the main signer. Notice that the <Constraint> 1224 is formatted differently than was presented in FIG. 7. This is a matter of format preference and has no technical implication.

When a decentralized architecture is used for signing a Web Page (or a Web Page Cluster), and when detached signatures are used for this purpose , there is a need to define a method that associates the Web Page and the file that carries the detached signature. A syntactical extension of the XHTML link element is used to provide reverse linkage between an XHTML document, its associated objects, and a cluster signature file. One or more link elements of the following form:

<link rev=“ClusterSignature” type+“text/xml” href=“ . . . ”/>

The href attribute provides an absolute or relative location of the cluster signature file. When a web engine encounters an XHTML (or HTML) page that carries this type of link element at the head of the document, it recovers the associated signature file for signature verification. If the signature verifies, the web engine runs and display the XHTML or HTML page.

Signature File Format

In one implementation, the format of signature files is composed of a subset of elements of the XML Digital Signature Standard, RFC 3275, “XML-Signature Syntax and Processing,” Internet Engineering Task Force (IETF), March 2002. An illustrative subset comprising the metadata expressions and comments appears in TABLE 1 :

TABLE 1

| [XML-DSIG] Elements | Support Conditions |
|---|---|
| Signature | Yes. It defines the root element. |
| SignedInfo | Yes. It defines the set of references for digest |
| | and signatures. |
| SignatureValue | Yes. It carries the actual signature for |
| | the document. |
| KeyInfo | Yes. It defines certificate retrieval mechanisms. |
| Object | Yes. It will carry a special time stamp |
| | for versioning |
| CanonicalizationMethod | Yes but the algorithms could be limited to a |
| | single canonicalization algorithm |
| | (C14n without comments) |
| SignatureMethod | Yes but the algorithms could be limited to |
| | RSA with SHAI. |
| Reference | Yes. It provides referencing function for |
| | external files and internal objects |
| | within the Signature construct. |
| Transforms | Yes but allowing possibly only a limited |
| | number of transforms: canonicalization |
| | and removal of attached signatures. |
| DigestMethod | Yes. It defines the standard SHA-1 algorithm |
| | as the means to provide a message hash. |
| DigestValue | Yes. It carries the actual digest value for |
| | a given Reference. |
| KeyName | May not be necessary for initial |
| | implementations |
| KeyValue | May not be necessary for initial |
| | implementations |
| RetrievalMethod | Yes. It is used to retrieve raw X.509 |
| | certificates from some location. |
| X509Data | Yes. A few of its children elements should |
| | be used to support X.509 certificates |
| | and CRLs. |
| PGPData | Not necessary. PGP is outside the scope |
| | of this type of digital signatures |
| SPKIData | Not necessary. SPKI issues are outside the |
| | scope this type of digital signatures |
| MgmtData | Not necessary. Deprecated by [XML-DSIG] |
| DSAKeyValue | Not necessary for initial implementations |
| RSAKeyValue | Not necessary for initial implementations |
| P, Q, G, J, Y, Seed, | Not necessary. DSA and its cryptographic |
| PgenCounter | attributes are outside the initial |
| | scope of this type of digital signatures |
| Modulus, Exponent | Not necessary for initial implementations. |
| | Separate declaration of RSA |
| | cryptographic attributes is not necessary |
| | if one uses certificates. |
| X509IssuerSerial | Not necessary for initial implementations. |
| | X509 information will be carried |
| | using certificates. |
| X5095KI | Not necessary for initial implementations. |
| | X509 information will be carried |
| | using certificates. |
| X509SubjectName | Not necessary for initial implementations. |
| | X509 information will be carried |
| | using certificates. |
| X509Certificate | Yes. Used for certificate insertion when |
| | necessary. |
| X509CRL | Yes. Used for CRL insertion when necessary. |
| PGPKeyId | Not necessary. PGP is outside the scope of |
| | this type of digital signatures |
| PGPKeyPacket | Not necessary. PGP is outside the scope of |
| | this type of digital signatures |
| SPKISexp | Not necessary. SPKI issues are outside the |
| | scope of this type of digital signatures |
| Manifest | Yes. It defines a less strict binding between |
| | digests and files during the core |
| | validation process. |
| SignatureProperties | Yes. It will be used for carrying signature |
| | document time stamps for versioning. |

The subset includes multiple <Reference> elements, each of which defines a file location, and which define also the transformations and algorithms for signatures. The <KeyInfo> element defines the location of additional public-key infrastructure (PKI) components to provide signatures. The additional PKI components include certificates and certificate revocation lists. The <DigestValue> provides the result of applying a one-way mathematical hash function to a file. After receiving the file, a receiver performs similar operations on the received file. Identical digest values are necessary for signature verification. The <SignatureValue> element carries the actual signature bytes derived from the proper transformation and signature algorithms. The transformation procedures include canonicalization, a method to minimize and exclude non-essential information in files prior to applying the digital signatures.

The <VersionNumber> element is to identify the most recent version of the digital signature. This element is not defined in the XML Digital Signature Standard, but is a novel implementation to enable tracking older files by receiving devices. When multiple versions of a signature have been cached by receiving devices, there is a need to determine which of those versions is the most current.

Time Stamp Versioning

In one implementation, a time stamp is used to provide versions for signature files but which serves also to provide source non-repudiation operations. In implementations having dynamic clusters, time stamp versioning is to provide versions for signature files which serves also to provide non-repudiation operations. This construct may be included in cluster signature files as well as attached file signatures. Referring to FIG. 13, a schema 1300 may be included in signature files under a separate namespace, using the <SignatureProperties> element of the XML Digital Signature Standard, RFC 3275, “XML-Signature Syntax and Processing,” Internet Engineering Task Force (IETF), March 2002.

Embodiments For Creating and Verifying Supplemental Content

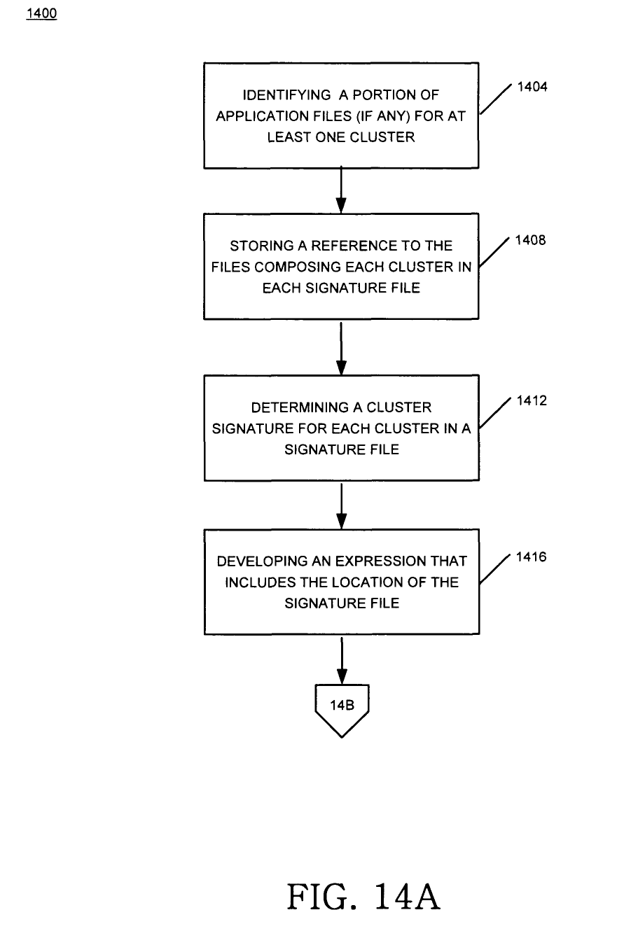

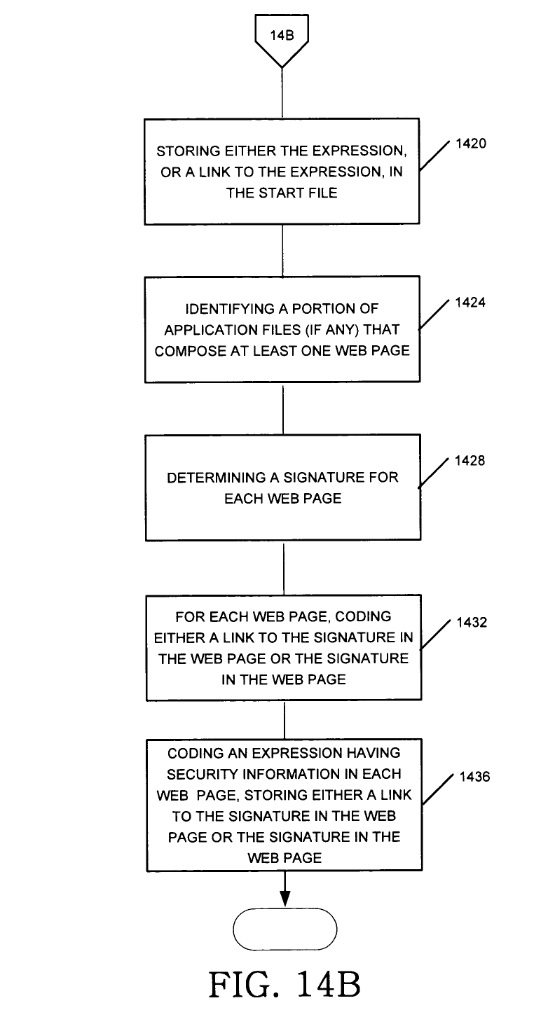

FIGS. 14A-14B portray a method 1400 to associate applications with their digital signatures. In one implementation, at least one processor in at least one supplemental television content server includes instructions that when executed by the processor(s), cause the processor(s) to execute the method 1400.

Operation 1404 identifies an at least one portion of application files (if any) with at least one cluster. This operation determines which files of an application will be clustered (if any), which will be identified with each cluster, and which files (if any) will have attached signatures or link to attached signatures. In one implementation, the identity of files to associate in a cluster are influenced by whether the files to be associated with the cluster are static or dynamic.

If files are clustered, they will have a security information resource file referencing a cluster signature file. The security information resource file in one implementation is included in the application start file. In one implementation, a link to the security information resource file is included in the application start file.

Operation 1408 stores a reference to the files composing each cluster in the cluster's signature file, such as a location or an identification of the files composing the cluster. In one implementation, the reference to the files is stored outside the signature file, such as in the security information resource file. In one implementation, a signature verification record is stored in the cluster signature file. In one implementation the time verification record is stored outside the signature file such as in the security information resource file. The time verification record is used for describing the version of the signature as a function of the files composing each cluster, and is used for determining whether a signature reflects the current cluster files for a dynamic cluster.

Operation 1412 determines the cluster signature for each cluster in a signature file. As described with reference to FIG. 2, in one implementation a detached signature file includes the hash code of each of the files composing the cluster, and a digital signature for signing at least the hash codes of each of the files.

Operation 1416 develops an expression that includes the location of the signature file for the files to be clustered. In one application, this is the security information resource file 100 described with respect to FIG. 1, and FIGS. 4-9 and 13. In one implementation, the security information resource file 100 is an XML metadata expression. As described with reference to FIG. 1, the security information resource file may include a cluster information expression, a signature location expression, and other information expressions. In one implementation, the security metadata resource file is signed to prevent unauthorized modifications to the information. Operation 1420 stores the expression, or a link to the expression, in the start file.

Operation 1424 identifies at least one portion of the application files (if any) that compose at least one web page. As described in the section describing the decentralized architecture section, a decentralized architecture enables the association of signatures directly to individual web-pages. The web pages may be static or dynamic web pages of markup language based applications. Dynamic web pages may be created at the client or server side.

Operation 1428 determines a signature for each web page. For each web page, operation 1432 codes in the web page either the signature or a link to the detached signature. Operation 1436 optionally codes in each web page an expression having security information. In one implantation, this is the security information resource file 100 described with respect to FIGS. 1 and 12. In one implementation, the security information resource file 100 is an XML metadata expression. As described with reference to FIG. 1, the security information resource file for a decentralized architecture includes other information about digitally signed applications, such as links to documents describing security policies and the identities of delegates that may sign the application in addition to the main signer. In one implementation, the security information resource file is signed to prevent unauthorized modifications to the information.

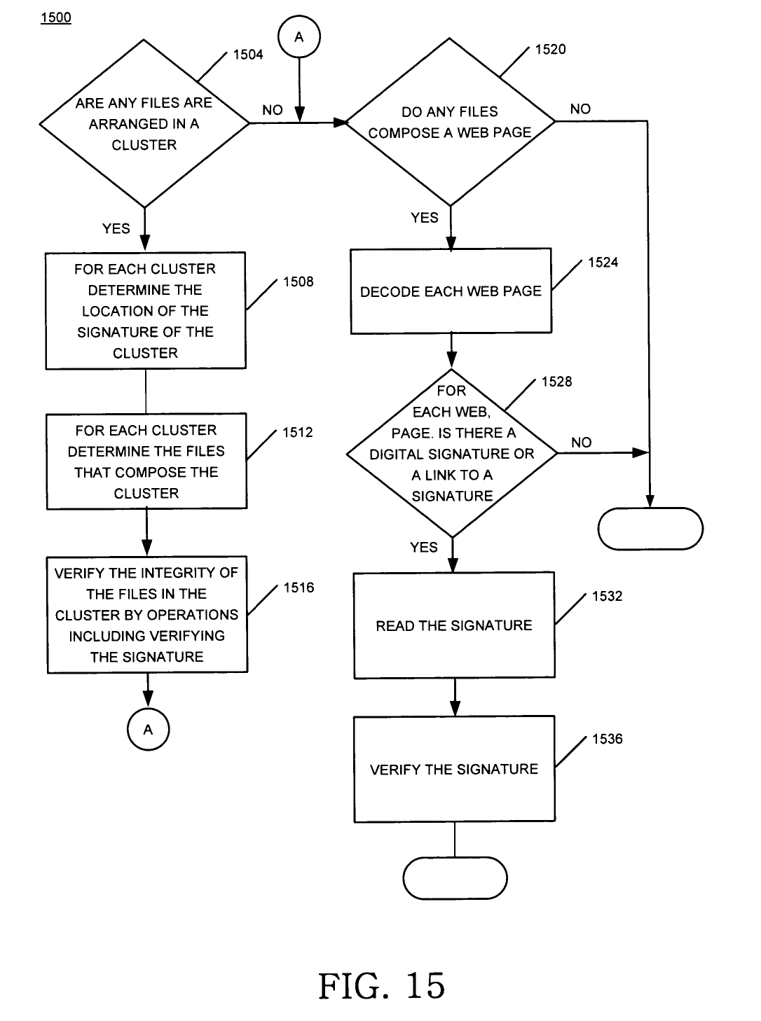

FIG. 15 portrays an exemplary method 1500 of processing digital signatures upon receiving supplemental television content application files. In one implementation, at least one processor in a supplemental television content client includes instructions that when executed by the processor(s), cause the processor(s) to execute the method 1500.

Operation 1504 determines whether any files are arranged in a cluster for a centralized architecture embodiment. In one implementation, an application start file is retrieved and decoded. If the application start file includes or references (points to) a security information resource file, the signature resource file indicates that there are files arranged in a cluster. The start file is an initial file or data structure carrying application run parameters, and which commonly references an application boot file which starts the actual execution of an application.

If there are any files arranged in a cluster, then the YES branch is taken from Operation 1504. Operation 1508 determines for each cluster the location of the signature of the cluster. In one implementation, the signature of each cluster is in a signature file 210. In one implementation, the signature information resource file 100 is decoded to obtain the location of the cluster signatures. Operation 1512 determines the files that compose the cluster. The files are commonly in the signature file or the security information resource file.

Operation 1512 determines the files that compose each cluster. In one implementation, a reference to the files composing each cluster is stored in the signature file and operation 1512 decodes the signature file to obtain the identify of the files. In one implementation, the security information resource file includes the files associated with each cluster and operation 1512 decodes the security information resource file to obtain the identify of the files.

Operation 1516 verifies the integrity of each of the files in a cluster by operations that include verifying the signature of each cluster. In one implementation, the signature information resource file includes a list of delegates and their constraints on delegate signature data (if any), and a list of applicable policy data (if any). In one implementation, the security resource file or the signature file includes time verification information to determine if the files that comprise a cluster have changed since the signature was calculated. In one implementation, the signature is verified by retrieving related certificates and revocation lists, verifying the status of the retrieved certificates and revocation lists, applying proper transformation procedures to the file, calculating the file digest value, and comparing the file digest value with the digest preset in the signature file. Signatures may also be provided by delegates. If signatures are provided by delegates, delegate constraints are checked. If time verification information is provided, this information is used in verifying the signature of each cluster. In one implementation, the security information resource file is signed and the security information resource file signature is verified.

If there are not any files arranged in a cluster, then the NO branch is taken form Operation 1504. Operation 1520 determines whether any files compose a Web Page for the decentralized architecture embodiment. If the YES branch is taken from operation 1520, operation 1524 decodes each web page to determine if the web page has a web page signature or a link to a web page signature. If the web page has a web page signature or a link to a web page signature, the YES branch is taken from operation 1528 and in operation 1532 the signature is read. In operation 1536 the signature is verified. In one implementation, the signature is verified by retrieving related certificates and revocation lists, verifying the status of the retrieved certificates and revocation lists, applying proper transformation procedures to the file, calculating the file digest value, and comparing the file digest value with the digest preset in the signature file. Signatures may also be provided by delegates. In one implementation the web page includes a signature information resource file which is decoded to obtain signature information such as delegate information to help in verifying the signature. If signatures are provided by delegates, delegate constraints are checked.

If in operation 1520 or 1528, the NO branch is taken, then the remaining files (if any) are considered not signed because a link element for digital signatures does not exist, an attached digital signature does not exist, and the file is not a component of an application cluster. A client operating system will typically warn the user that a file has not been signed or that a signature is not valid. A user may decide to continue the installation process or not. The operating system may reject the file. If the purpose is to install and run the software automatically which is a typical interactive television application, then a standards may mandate that unsigned applications will have restricted access to system resources. This means that unsigned applications may be able to display some things on the screen but would not be able to do some more threatening operations like accessing a local file or connecting to some computer over the internet. Typically, an unsigned application runs in a sandbox, and only signed applications can do things outside the sandbox.

The phraseology and terminology used is for the purpose of description and should not be regarded as limiting. The language in the patent claims may not capture every nuance, or describe with complete precision the range of novelty. Moreover, it is understood that the depicted acts in any described method are not necessarily order dependent, and in an implementation there may be intervening acts.

Several other implementations are possible, including the following derived from FIG. 15: (1) An application may not process operation 1504 through operation 1516 because it does not include a centralized signature schema, (2) an application may process operation 1520 to operation 1536 at the time of running and not during initialization, (3) an application may process some clusters using operation 1504 through operation 1516 during initialization, but process other clusters at the time of running and only if needed.

The present invention is not limited by what has been particularly shown and described herein above. The specific features and operations are disclosed as exemplary forms of implementing the claimed subject matter. It is to be understood that the invention is not necessarily limited to the specific features or diagrams described. The scope of the invention is defined by the claims which follow.

I claim:

1. A method of signing a supplemental television content application comprising files, the method comprising:
identifying at least a first portion of the files in at least one cluster;
determining a cluster signature for each cluster; and
developing an expression that includes the location of the signature.

2. The method of claim 1 wherein said signature for each cluster is based on a hash code of the files composing the cluster.

3. The method of claim 1 wherein the application comprises a start file and further comprising storing the expression in the start file.

4. The method of claim 1 wherein the application comprises a start file and further comprising storing a link to the expression in the start file.

5. The method of claim 1 further comprising storing at least one of delegate information, security policy information, time version information, and file identification information for each cluster in the expression.

6. The method of claim 1 further comprising storing the cluster signature in a signature file, developing a reference to the files composing the cluster, and storing the reference to the files in the signature file.

7. The method of claim 1 further comprising storing the cluster signature in a signature file, developing a time version record for the cluster, and storing the time version record in the signature file.

8. The method of claim 1 further comprising developing at least one of a reference to the files composing the cluster, and a time version record for the cluster.

9. The method of claim 1 wherein a second portion of the files comprises a web page and further comprising determining a signature for each web page.

10. The method of claim 9 wherein the web pages is at least one of a markup language based application and dynamically created by a client.

11. The method of clam 9 further comprising at least one of:
developing a link to the signature and storing the link in the web page; and
storing the signature in the web page.

12. A method of signing a supplemental television content application comprising files, the method comprising:
identifying a first portion of the files that together compose a web page;
determining a signature for the web page; and
storing one of a link to the signature in the web page, or the signature in the web page.

13. The method of claim 12 further comprising developing an expression that includes signature information, and storing the expression in the web page.

14. The method of claim 13 wherein the expression comprises at least one of security policy information data, and delegate data.

15. The method of claim 12 further comprising:
clustering at least a second portion of the files in at least one cluster;
determining a cluster signature for each cluster; and
developing an expression that includes indicating the location of the clusters.

16. A method of executing a supplemental television content application that comprises files, the method comprising:
determining if any of the files are arranged in a cluster;
for each cluster,
determining the location of the signature of the cluster;
determining the files that compose the cluster; and
verifying the integrity of the files in the cluster by operations including verifying the signature.

17. The method of claim 16 wherein the determining if any of the files are arranged in clusters operation further comprises:
determining if an application start file has a record that includes one of
a reference to an expression having the location of the signature, and
the expression;
reading from the expression the location of a file having a signature of a cluster for each cluster; and
and determining if the signatures can be verified.

18. The method of claim 17 wherein each of the files composing a cluster is stored in one of
the expression, and
a file storing a signature.

19. The method of claim 17 wherein each signature is based on a hash of each file composing the cluster.

20. The method of claim 17 wherein the reading operation further comprises reading whether there are any delegates for any of the clusters, and determining if a signature is valid based on the delegates.

21. The method of claim 17 further comprising reading time version information associated with a cluster and determining if the signature may be valid based on the time version information.

22. The method of claim 16 further comprising determining if any of the files is a web page file having one of a link to a signature and a signature; reading the signature, and verifying the signature.

23. A method of executing a supplemental television content application comprising files, the method comprising:
determining if any files compose web pages; and
if any of the files compose web pages, then
for each of the web pages, decoding the web page to determine if the web page has one of a link to a digital signature and a digital signature,
reading the signature, and
verifying the signature.

24. The method of claim 23 further comprising:
determining if any of the files are arranged in a cluster;
for each cluster, determining the files that compose the cluster and the location of the signature of the cluster;
verifying the integrity of the files in the cluster by operations including verifying the signature.

25. A supplemental television content architecture comprising:
application files;
at least one of:
(a) an at least one signature file having a signature of at least a portion of said application files detached from said application files; and a start file having one of an expression having a link to each signature file, and a link to an expression having a link to each signature file; and
(b) an at least one web page comprising at least a portion of said application files and each web page coded with one of an signature and a link to the signature.

26. The architecture of claim 25 wherein the expression further has cluster information.

27. The architecture of claim 25 wherein the expression further has at least one of delegate information and security policy information.

28. The architecture of claim 25 wherein the signature file further has at least one of a reference to cluster files and time version information.

29. The architecture of claim 25 wherein the web page further comprises a metadata expression.

30. The architecture of claim 29 wherein the metadata expression comprises at least one of security policy information and signature delegate information.

31. One or more computer readable media having stored thereon a plurality of instructions that, when executed by at least one processor, causes the processor to perform acts comprising:
identifying at least a first portion of supplemental television content application files in at least one cluster;
determining a cluster signature for each cluster; and
developing an expression that includes the location of the signature.

32. The computer readable media of claim 31 wherein the signature for each cluster is based on a hash code of the files composing the cluster.

33. The computer readable media of claim 31 wherein the application comprises a start file and said acts further comprise storing the expression in the start file.

34. The computer readable media of claim 31 wherein the application comprises a start file and said acts further comprise storing a link to the expression in the start file.

35. The computer readable media of claim 31 wherein the expression further includes at least one of delegate information, security policy information, time version information, and file identification information for each cluster.

36. The computer readable media of claim 31 wherein said acts further comprises storing the cluster signature in a signature file, developing a reference to the files composing the cluster, and storing the reference to the files in the signature file.

37. The computer readable media of claim 31 wherein said acts further comprise storing the cluster signature in a signature file, developing a time version record for the cluster, and storing the time version record in the signature file.

38. The computer readable media of claim 31 wherein said acts further comprise developing at least one of a reference to the files composing the cluster, and a time version record for the cluster.

39. The computer readable media of claim 31 wherein a second portion of the files comprises a web page and further comprising determining a signature for each web page.

40. The computer readable media of claim 39 wherein the web pages is at least one of a markup language based application and dynamically created by a client.

41. The computer readable media of claim 39 wherein said acts further comprise at least one of:
developing a link to the signature and storing the link in the web page; and
storing the signature in the web page.

42. One or more computer readable media having stored thereon a plurality of instructions that, when executed by at least one processor, causes the processor to perform acts comprising:
identifying a first portion of supplemental television content application file that together compose a web page;
determining a signature for the web page; and
storing one of a link to the signature in the web page, or the signature in the web page.

43. The computer readable media of claim 42 wherein said acts further comprise developing an expression that includes signature information, and storing the expression in the web page.

44. The computer readable media of claim 43 wherein the expression comprises at least one of security policy information data, and delegate data.

45. The computer readable media of claim 42 wherein said acts further comprise:
clustering at least a second portion of the files in at least one cluster;
determining a cluster signature for each cluster; and
developing an expression that includes indicating the location of the clusters.

46. One or more computer readable media having stored thereon a plurality of instructions that, when executed by at least one processor, causes the processor to perform acts comprising:
determining if any supplemental television content application files are arranged in a cluster;
for each cluster,
determining the location of the signature of the cluster files that compose the cluster;
determining the files that compose the cluster; and;
verifying the integrity of the files in the cluster by operations including verifying the signature.

47. The computer readable media of claim 46 wherein the act of determining if any of the files are arranged in clusters further comprises:
determining if an application start file has a record that includes one of
a reference to an expression having the location of the signature, and
the expression;
reading from the expression the location of a file having a signature of a cluster for each cluster; and
and determining if the signatures can be verified.

48. The computer readable media of claim 47 wherein each of the files composing a cluster is stored in one of
the expression, and
a file storing a signature.

49. The computer readable media of claim 47 wherein each signature is based on a hash of each file composing the cluster.

50. The computer readable media of claim 47 wherein the act of reading further comprises reading whether there are any delegates for any of the clusters, and determining if a signature is valid based on the delegates.

51. The computer readable media of claim 47 further comprising reading time version information associated with a cluster and determining if the signature may be valid based on the time version information.

52. The computer readable media of claim 46 wherein said acts further comprise determining if any of the files is a web page file having one of a link to a signature and a signature; reading the signature, and verifying the signature.

53. One or more computer readable media having stored thereon a plurality of instructions that, when executed by at least one processor, causes the processor to perform acts comprising:
determining if any supplemental television content application files compose web pages; and
if any of the files compose web pages, then
for each of the web pages, decoding the web page file to determine if the web page has one of a link to a digital signature and a digital signature,
reading the signature, and
verifying the signature.

54. The computer readable media of claim 57, the acts further comprising:
determining if any of the files are arranged in a cluster;
for each cluster, determining the files that compose the cluster and the location of the signature of the cluster;
verifying the integrity of the files in the cluster by operations including verifying the signature.
